(19) United States
(12) Patent Application Publication
(10) Pub. No.: US 2025/0264669 A1
(43) Pub. Date: Aug. 21, 2025

(54) DUST CAP STRIP FOR AN ADAPTER ELEMENT OF A FIBER OPTIC NETWORK

(71) Applicant: CORNING RESEARCH & DEVELOPMENT CORPORATION, Corning, NY (US)

(72) Inventor: Diana Rodriguez, Mansfield, TX (US)

(21) Appl. No.: 19/018,116

(22) Filed: Jan. 13, 2025

Related U.S. Application Data
(60) Provisional application No. 63/555,453, filed on Feb. 20, 2024.

(51) Int. Cl. G02B 6/38

(52) U.S. Cl. CPC G02B 6/3849

(57) ABSTRACT

A dust cap strip for an adapter element in a fiber optic network. The dust cap strip includes an elongate strip body having a first end, a second end, and a plurality of dust cap bodies, wherein each of the plurality of dust cap bodies is connected to an adjacent dust cap body. Each dust cap body includes a flange and a plug extending from the flange. When the dust cap strip is engaged with the adapter element, the plug of each dust cap body is received in at least one of the connector ports of the adapter element and the flange of each dust cap body is in abutting or near abutting relationship with a connection face of the adapter element. In this way, the dust caps of a large group of connector ports or even all the connector ports of the adapter element may be removed by a single pulling operation.

### PRIORITY APPLICATION

This application claims the benefit of priority of U.S. Provisional Application No. 63/555,453, filed on Feb. 20, 2024, the content of which is relied upon and incorporated herein by reference in its entirety.

### TECHNICAL FIELD

The invention relates generally to fiber optic connectivity, and more specifically to a dust cap strip for an adapter element of a fiber optic network, such as at an intermediate distribution frame in a data center, and to a method of using the dust cap strip in a fiber optic cable assembly.

### BACKGROUND

The large amount of data and other information transmitted over the internet has led businesses and other organizations to develop large scale data centers for organizing, processing, storing and/or disseminating large amounts of data. Data centers contain a wide range of network equipment including, for example, servers, networking switches, routers, storage subsystems, etc. Data centers further include a large amount of cabling and equipment racks to organize and interconnect the network equipment in the data center. Modern data centers may include multi-building campuses having, for example, one primary or main building and a number of auxiliary buildings in close proximity to the main building. All the buildings on the campus are interconnected by a local fiber optic network.

Data center design and cabling-infrastructure architecture are increasingly large and complex. To manage the interconnectivity of a data center, the network equipment within the buildings on the data center campus is often arranged in structured data halls having a large number of spaced-apart rows. Each of the rows is, in turn, configured to receive a number of equipment racks or cabinets (e.g., twenty racks or cabinets) which hold the network equipment. In some data center architectures, each of the rows includes an intermediate distribution frame at a front or head end of the row. Building fiber optic cables with a relatively large number of optical fibers (high fiber counts) are routed from a building distribution frame to the intermediate distribution frame for the different rows of equipment racks. At the intermediate distribution frame, a large number of distribution fiber optic cables with lower fiber counts are connected to the optical fibers of the associated high fiber count building fiber optic cable(s) and routed along the row to connect to the network equipment held in the various racks in the row. To organize the large number of in-row distribution fiber optic cables, each row typically includes a cable tray or basket disposed above the row for supporting the distribution fiber optic cables as they extend along the row. The network equipment in the racks is optically connected to the distribution fiber optic cables by technicians during the construction of the data center using a large number of jumper cables.

A large number of optical connections between the building fiber optic cables and the distribution fiber optic cables are made at the intermediate distribution frame. For this reason, the intermediate distribution frame typically includes a large number of adapters that define a corresponding large number of rear connector ports and front connector ports on opposite sides of the adapters. Optical fibers from the building fiber optic cables are terminated by a large number of building fiber optic connectors. Similarly, optical fibers from the distribution fiber optic cables are terminated by a large number of distribution fiber optic connectors. To make optical connections between the two fiber optic cables at the intermediate distribution frame, an installer must insert the building fiber optic connectors into respective rear connector ports and insert the distribution fiber optic connectors into respective front connector ports of the adapters held in the intermediate distribution frame.

In many cases, the intermediate distribution frames are assembled with adapters in advance of the installers making the fiber optic connections at the intermediate distribution frame. In order to keep dust and other debris from contaminating the adapters, the adapters typically include individual dust caps (also referred to as dust plugs) for each of the connector ports of the adapter (i.e., both front and rear connector ports). Thus, prior to making fiber optic connections at the intermediate distribution frame, installers must first remove the dust caps from the connector ports. Given that the connector density of intermediate distribution frames is exceedingly high (and is expected to go higher in the future), removing the individual dust caps is a tedious and laborious task and takes an inordinate amount of time. Additionally, after installation, one is left with a large number of individual dust caps dispersed about the intermediate distribution frame (e.g., typically on the floor of the facility) that must be cleaned up and disposed of.

Accordingly, installers seek improvements to optical connectivity at an intermediate distribution frame or other patch panels of a fiber optic network that overcomes these drawbacks in handling dust caps during an install.

### SUMMARY

In one aspect of the disclosure, a dust cap strip for an adapter element used for making connections in a fiber optic network is disclosed. The adapter element includes a plurality of connector ports and a connection face adjacent the plurality of connector ports. The dust cap strip includes an elongate strip body having a first end, a second end, and a plurality of dust cap bodies extending between the first end and the second end. Each of the plurality of dust cap bodies is connected to at least one adjacent dust cap body along an interface. Each dust cap body includes a flange and a plug extending from the flange. When the dust cap strip is engaged with the adapter element, the plug of each dust cap body is received in at least one of the plurality of connector ports of the adapter element and the flange of each dust cap body is in abutting relationship or near abutting relationship with the connection face of the adapter element adjacent the at least one of the plurality of connector ports.

In one embodiment, the elongate strip body may be generally flexible. For example, the elongate strip body may be formed from a generally flexible material, such as rubber or other flexible material. Alternatively, the elongate strip body may include flexible portions that allow portions of the strip body to flex relative to other portions of the strip body. In one embodiment, the interface between two adjacent dust cap bodies may include a tear line. This allows adjacent dust cap bodies to be selectively separated from each other. In one exemplary embodiment, for example, the tear line may include perforations that facilitate the separation of adjacent dust cap bodies. Moreover, in one embodiment, the interface between two adjacent dust cap bodies may include a bend line that allows adjacent dust cap bodies to flex relative to each other. In an exemplary embodiment, for example, the bend line may include a groove, such as a V-groove or other indentation that promotes bending. In one embodiment, the tear line and the bend line may coincide with each other, such as at the interface between adjacent dust cap bodies. For example, in one embodiment, the interface between two adjacent dust cap bodies may be along side edges of the flanges of adjacent dust cap bodies.

In one embodiment, for each dust cap body of the plurality of dust cap bodies, the flange may be sized relative to the plug to define a ledge around a periphery of the plug. The ledge is configured to confront the connection face of the adapter element, and may abut the connection face when the dust cap strip is engaged with the adapter element. In one embodiment, the plug of the dust cap bodies may be generally rectangular in shape and may be generally hollow and/or open ended. The plug may alternatively be solid. Additionally, in one embodiment, at least one dust cap body of the plurality of dust cap bodies may include a pull tab extending from the flange. For example, the dust cap body adjacent the first end of the elongate strip body and/or the dust cap body adjacent the second end of the elongate strip body may include a pull tab. Alternatively, each of the plurality of dust cap bodies my include a pull tab. In an exemplary embodiment, the pull tab of the at least one of the plurality of dust cap bodies may extend from a side of the flange opposite the plug.

In one embodiment, the adapter element may include a multi-port adapter having the plurality of connector ports and each of the plurality of dust cap bodies may be configured to be received in a respective one of the plurality of connector ports of the adapter. In another embodiment, the adapter element may include a ganged adapter including a plurality of adapters arranged adjacent to each other, and each adapter of the plurality of adapters may include at least one connector port of the plurality of connector ports. In this embodiment, each of the plurality of dust cap bodies may be configured to be partially received in the at least one connector port of a respective adapter of the plurality of adapters in the ganged adapter.

In another aspect of the disclosure, a fiber optic assembly includes an adapter element used for making connections in a fiber optic network and at least one dust cap strip according to the first paragraph of this Summary engaged with the adapter element. The adapter element includes a plurality of connector ports and a connection face adjacent the plurality of connector ports.

In one embodiment, the adapter element may include an adapter having the plurality of connector ports, and wherein each of the plurality of dust cap bodies is configured to be received in a respective one of the plurality of connector ports of the adapter. In an alternative embodiment, the adapter element may include a ganged adapter having a plurality of adapters arranged adjacent to each other. Each adapter of the plurality of adapters includes at least one connector port of the plurality of connector ports, and each of the plurality of dust cap bodies is configured to be partially received in the at least one connector port of a respective adapter of the plurality of adapters in the ganged adapter.

In one embodiment, the fiber optic assembly may further include a housing configured to hold the adapter element. For example, in one embodiment, the housing may include an interface band for holding the plurality of adapters in the ganged adapter. In this embodiment, the interface band may be configured to engage with a tray used in an intermediate distribution frame or other racking/patching structure in the fiber optic network, for example. In another embodiment, the housing may include a bezel plate for holding the plurality of adapters in the ganged adapter. In this embodiment, the bezel plate may be configured to be attached to a panel of an intermediate distribution frame or other racking/patching structure in the fiber optic network, such as through a releasable connection, for example. In yet a further embodiment, the housing may include a panel for holding the plurality of adapters in the ganged adapter. In this embodiment, the panel may be configured to be attached to an intermediate distribution frame or other racking/patching structure in the fiber optic network, for example.

In one embodiment, the plurality of adapters of the ganged adapter may be arranged in an array having a least one row or at least one column. Each of the plurality of dust cap bodies of the at least one dust cap strip is configured to be partially received in the at least one connector port of a respective adapter of the plurality of adapters in the ganged adapter that forms the at least one row or the at least one column in the array. In another embodiment, the array includes a plurality of rows and a plurality of columns, and each of the plurality of dust cap bodies of the at least one dust cap strip is configured to be partially received in the at least one connector port of a respective adapter of the plurality of adapters in the ganged adapter that forms at least two rows or at least two columns in the array. In still a further embodiment, the array includes a plurality of rows and a plurality of columns, the at least one dust cap strip includes a plurality of dust cap strips, and each of the plurality of dust cap bodies of each dust cap strip is configured to be partially received in the at least one connector port of a respective adapter of the plurality of adapters in the ganged adapter that forms one row or one column in the array.

In another aspect of the disclosure, a fiber optic cable assembly includes a fiber optic cable carrying a plurality of optical fibers. The fiber optic cable includes at least one optical interface at (at least) one end of the fiber optic cable for connection to network equipment. The at least one optical interface includes a plurality of fiber optic connectors terminating at least some of the plurality of optical fibers of the fiber optic cable, a plurality of adapters arranged adjacent to each other to define an adapter array, and at least one dust cap strip according to the first paragraph of this Summary section connected to the adapter array. Each of the plurality of adapters of the adapter array includes at least one first connector port on a first connection face of the adapter and at least one second connector port on a second connection face of the adapter, such that the adapter array includes a plurality of the first connector ports and a plurality of the second connector ports. The adapter array includes a first array connection face including the plurality of first connector ports and a second array connection face including the plurality of second connector ports. Each fiber optic connector of the plurality of fiber optic connectors is connected to a respective second connector port of the plurality of second connector ports, and the dust cap strip is connected to the plurality of first connector ports on the first array connection face of the optical interface. Each of the plurality of dust cap bodies of the dust cap strip is partially received in the at least one first connector port of a respective adapter of the plurality of adapters in the adapter array.

In one embodiment, each fiber optic connector of the plurality of fiber optic connectors of the at least one optical interface is a multi-fiber connector. Additionally, in one embodiment, each adapter of the plurality of adapters of the at least one optical interface may include at least two, and preferably at least four, first connector ports on the first connection interface and at least two, and preferably at least four, second connector ports on the second connection interface. Moreover, in one embodiment, the adapter array of the at least one optical interface may include at least four adapters. For example, the plurality of adapters may be arranged side-by-side, either directly in contact with each other or slightly spaced from each other, to define the adapter array of the at least one optical interface. Alternatively, the plurality of adapters may be arranged in so that the adapter array has a plurality of rows and a plurality of columns.

In another aspect of the disclosure, a method of making a fiber optic cable assembly includes providing a fiber optic cable carrying a plurality of optical fibers. The plurality of optical fibers at (at least) one end of the fiber optic cable is terminated by a plurality of fiber optic connectors. The method further includes providing an adapter array defined by a plurality of adapters arranged adjacent to each other. The adapter array includes a first array connection face including a plurality of first connector ports of the plurality of adapters and a second array connection face including a plurality of second connector ports from the plurality of adapters. The method further includes inserting each of the plurality of fiber optic connectors of the fiber optic cable into a respective second connector port of the plurality of second connector ports and applying a dust cap strip according to the first paragraph of this Summary section to the first array connection face of the adapter array. Each of the plurality of dust cap bodies of the dust cap strip is partially received in at least one of the first connector ports of a respective adapter of the plurality of adapters in the adapter array.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an exemplary embodiment of the disclosure.

FIG. 2 is a partial perspective view of an exemplary data hall of the data center shown in FIG. 1 according to one embodiment.

FIG. 3 is an enlarged partial perspective view of the exemplary data hall shown in FIG. 2.

FIG. 4 is a perspective view of an exemplary fiber optic cable assembly with one adapter.

FIG. 5 is a perspective view of an exemplary fiber optic cable assembly with a ganged adapter.

FIG. 6 is a perspective view of a dust cap strip according to an embodiment of the disclosure.

FIG. 7 is another perspective view of the dust cap strip of FIG. 6.

FIG. 8 is a perspective view of the fiber optic cable assembly of FIG. 5 with the dust cap strip of FIG. 6 connected to it.

FIG. 9A is a perspective view of a fiber optic cable assembly with a dust cap strip installed in a tray assembly.

FIG. 9B is a perspective view of the tray assembly of FIG. 9A with a distribution fiber optic cable connected to the fiber optic cable assembly.

FIG. 10 is a perspective view of a dust cap strip according to another embodiment of the disclosure.

FIG. 11 is another perspective view of the dust cap strip of FIG. 10.

FIG. 12 is a perspective view of an optical interface according to an alternative embodiment of the disclosure.

FIG. 13 is a disassembled perspective view of the optical interface shown in FIG. 12.

FIG. 14 is a perspective view of an optical interface according to a further alternative embodiment of the disclosure.

FIG. 15 is a disassembled perspective view of the optical interface shown in FIG. 14.

FIG. 16 is a perspective view of the optical interface shown in FIG. 14 being attached to a panel.

FIG. 17 illustrates a panel having a plurality of optical interfaces as shown in FIG. 14, attached thereto.

FIG. 18 is a perspective view of an optical interface according to yet another embodiment of the disclosure.

### DETAILED DESCRIPTION

Various embodiments will be further clarified by examples in the description below. In general, the description relates to a dust cap strip that may be used in a single adapter with multiple connector ports, in one configuration. In another configuration, a dust cap strip may be used in a adapter array, preferably defined by a group of multi-port adapters and possibly “ganged” together to form a ganged adapter, to cover each of the connector ports in the group of adapters. In either configuration, the dust cap strip includes one or more pull tabs that allow the entire dust cap strip to be removed from the plurality of connector ports in a single motion or operation by the installer. Thus, the installer may grab an end of the dust cap strip and remove it in one pulling motion, thereby immediately exposing a group and possibly all of the connector ports in the adapter or adapter array without having to remove numerous individual dust caps, as is the case in conventional arrangements.

By way of example, a tray or panel of an intermediate distribution frame or other racking/patching structure of the fiber optic network may include at least one and possible multiple optical interfaces, where each optical interface may include a plurality of adapters, and each adapter may include four connector ports. Thus, in that single tray/panel there would be a large number of individual connector ports (e.g., on just one side of the adapter). Conventionally, it would take a corresponding large number of dust caps to prevent contamination of the optical interfaces and an installer would have to remove each of those individual dust caps during installation. According to one aspect of the disclosure, a dust cap strip may be configured to plug a group or possibly all the connector ports associated with the optical interface. Thus, a smaller number of plug components are needed to prevent contamination of the optical interface. Perhaps more importantly, however, technicians need only remove a relatively small number of individual plug components during installation. This saves significant time, labor, and costs during installation in, for example, a data center or the like having a large number of optical interfaces for making optical connections.

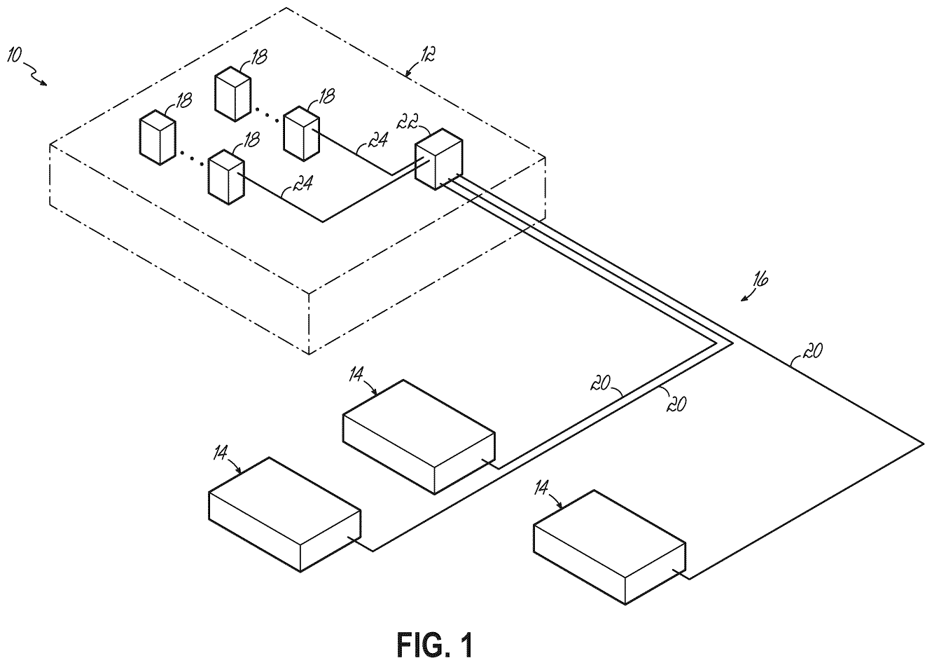

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 (“indoor cables 24”) are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14.

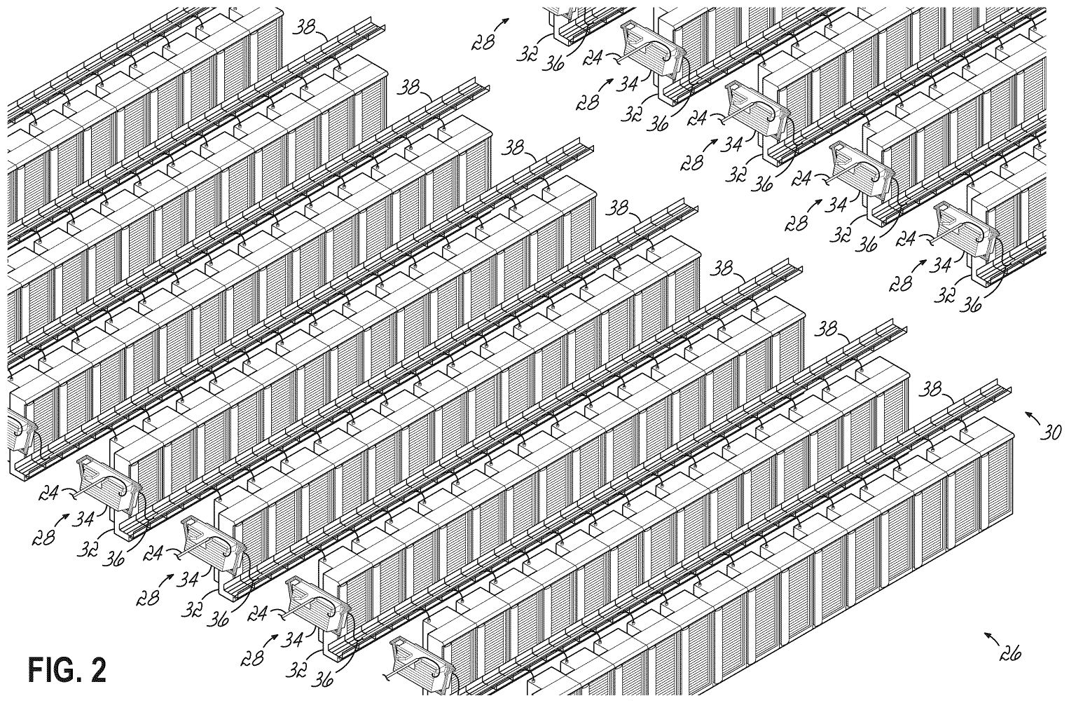

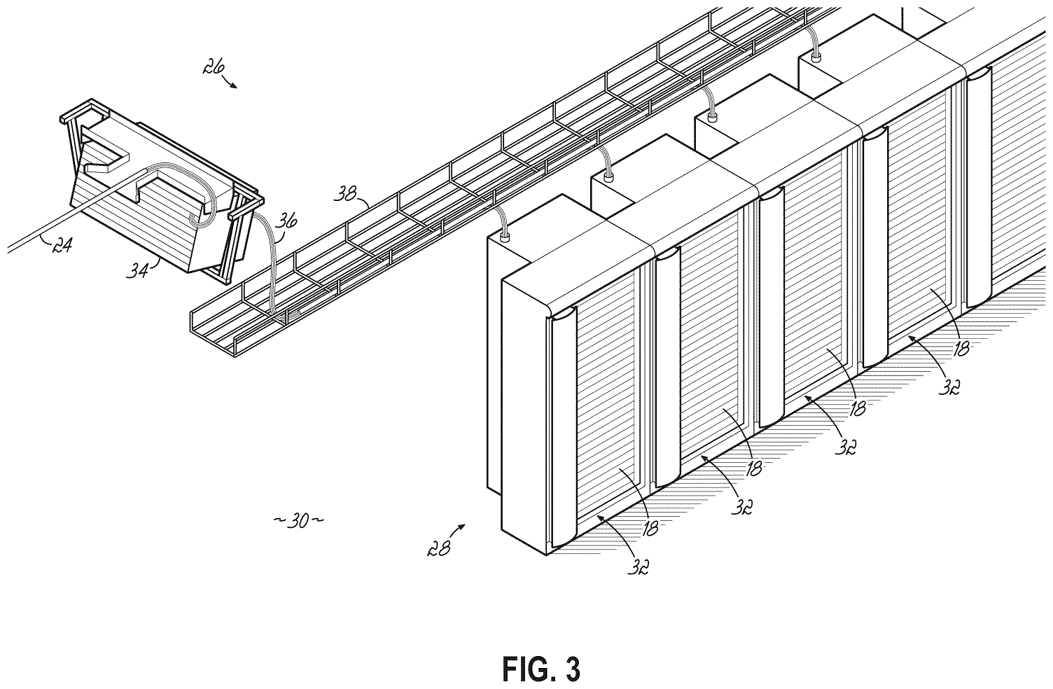

As illustrated in more detail in FIGS. 2 and 3, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of equipment racks or cabinets 32 (referred to hereafter as “racks 32”) generally arranged one next to the other along the row 28. Each of the racks 32 is a vertically arranged framework for holding various network equipment 18 of the data center 10, as is generally known in the telecommunications industry.

In one common arrangement, and as further illustrated in FIG. 2, each row 28 may include an intermediate distribution frame 34 at the head end of the row 28 closest to the access pathway 30. The intermediate distribution frame 34 represents a termination point of at least some of the optical fibers carried by one or more of the indoor cables 24, for example. Although the intermediate distribution frame 34 is shown as being positioned above the row 28, in other embodiments, the intermediate distribution frame 34 may be in a cabinet (not shown) at the head end of the row 28 or in the first equipment rack 32 at the head end of the row 28. In yet other embodiments, the intermediate distribution frame 34 may be located within the associated row, such as in the middle of the row, and be above, below, or within one of the equipment racks 32. As discussed in the Background section above, in a conventional arrangement, one or more distribution cables 36 (only a representative one is shown in FIGS. 2 and 3) are connected to the intermediate distribution frame 34 of a row 28 and routed along a cable tray 38 generally disposed above the row 28. The network equipment 18 in the equipment racks 32 is then optically connected to the one or more distribution cables 36 to provide the interconnectivity of the network equipment 18 of the data center 10.

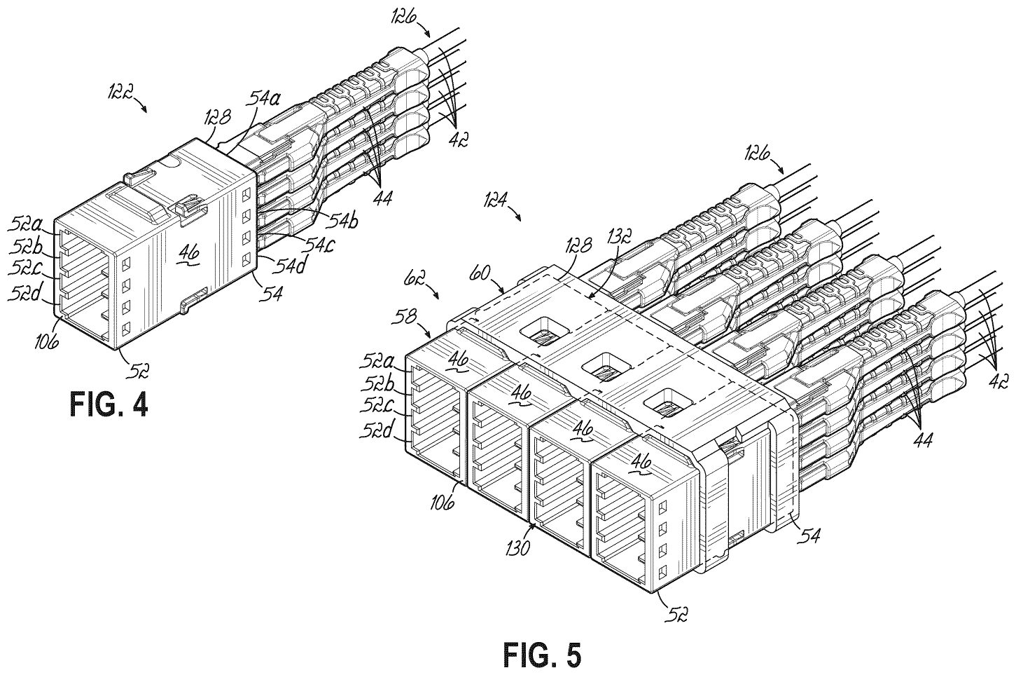

FIG. 4 shows four cable legs 42 of a fiber optic cable each terminated with a fiber optic connector 44 that is plugged into an adapter 46. The four cable legs 42 may be at least part of the indoor fiber optic cable 24 that enters the intermediate distribution frame 34 as shown in FIGS. 2 and 3. Indeed, in the examples described below, the adapter 46 is described with use in the intermediate distribution frame 34 in mind. However, the adapter 46 may be used in other contexts, such as in network equipment 18 (FIG. 2) in the equipment racks 32. Thus, in some embodiments the four cable legs 42 may alternatively be at least part of one or more distribution cables 36, and the adapter 46 may be used to establish connections between such distribution cable(s) 36 and other fiber optic cables used in the data center 10 (e.g., patch cords or cable harnesses that extend between different network equipment 18 within one of the equipment racks 32).

The connectors 44 are shown in the form of MMC connectors, which are multi-fiber connectors available from US Conec Ltd. However, any conventional, or yet to be developed, optical connector may be used in other embodiments, including, but not limited to simplex or duplex connectors (e.g., LC connectors) and other multi-fiber connectors (e.g., MPO connectors). The adapter 46 is considered to be of a type that corresponds to the connectors 44. Thus, the adapter 46 in the embodiment shown is considered to be a MMC-type adapter.

As shown in FIG. 4, the adapter 46 includes four front connector ports 52a, 52b, 52c, 52d on a front side 52 of the adapter 46 and four rear connector ports 54a, 54b, 54c, 54d on a rear side 54 of the adapter 46. Adapter 46, however, is not limited to having only four connector ports, but could have any number of front and rear connector ports in alternative embodiments (e.g., one, two, three, five, six, etc.). For example, in one embodiment, the adapter 46 may include at least two front connector ports and at least two rear connector ports. In a preferred embodiment, however, the adapter 46 may include at least four front connector ports and at least four rear connector ports. Thus, the adapter 46 should not be limited to any specific number of connector ports. Each of the fiber optic connectors 44 may be plugged into respective rear connector ports 54a, 54b, 54c, 54d at the rear side 54 of the adapter 46.

FIG. 5 shows a plurality of adapters 46 positioned adjacent to each other to define an adapter array, and specifically a ganged adapter 58. In the depicted embodiment, the ganged adapter 58 includes four adapters 46 arranged side-by-side to define the ganged adapter 58. However, it is to be understood that, in alternative embodiments, the ganged adapter 58 may include fewer or more adapters 46 and may include the adapters 46 in various arrangements. In one embodiment, the front connector ports 52a, 52b, 52c, 52d and rear connector ports 54a, 54b, 54c, 54d may have a horizontal orientation in each of the plurality of adapters 46 in the ganged adapter 58. Alternatively, however, the front connector ports 52a, 52b, 52c, 52d and rear connector ports 54a, 54b, 54c, 54d may have a vertical orientation in each of the plurality of adapters 46 of the ganged adapter 58. An interface housing 60 is configured to hold (or house) the ganged adapter 58. In the embodiment shown in FIG. 5, for example, the interface housing 60 may be configured as an interface band. However, in alternative embodiments, the interface housing 60 may have other configurations, as will be discussed below in greater detail. Together, the ganged adapter 58 and the interface housing 60 form an optical interface 62. As used herein, the term adapter element may refer to a single adapter 46 or an array of adapters 46 (including the ganged adapter 58) or any other single adapter or plurality of adapters in configurations different from what is described or illustrated herein.

During installation, the optical interface 62 may be prepared and placed within the intermediate distribution frame 34, or other racking/patching structure in the fiber optic network, well prior to one of the distribution fiber optic cables 36 being connected to the optical interface 62. In the interim, dust, dirt, and other debris may enter the open connector ports 52a, 52b, 52c, 52d and potentially block, obscure, or even damage the end faces of the fiber optic connectors 44 that extend into the rear side 54 of the adapter 46 or ganged adapter 58. The end faces of the fiber optic connectors 44 present ends of optical fibers for mating such that the debris may potentially block, obscure, or even damage the optical fiber ends themselves. Either situation can result in the debris interfering with optical signals between the optical fibers being connected across the adapter 46 or ganged adapter 58, leading to significant and unacceptable signal loss across the optical connection. Conventionally, to prevent the egress of such debris, individual dust caps have been used to cover each individual connector port 52a, 52b, 52c, 52d of the adapter 48 or ganged adapter 58. Using individual dust caps, however, has drawbacks as discussed above.

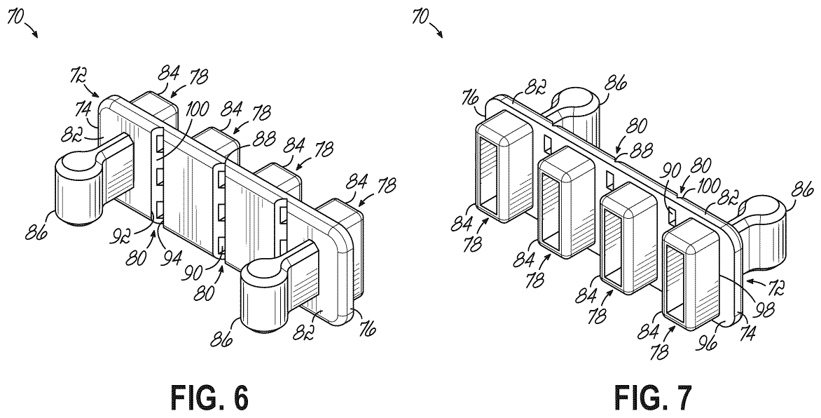

A dust cap strip 70 according to one aspect of the disclosure addresses the drawbacks of using individual dust caps to cover the connector ports 52a, 52b, 52c, 52d of the adapter element, whether that be for a single adapter 46 or a ganged adapter 58. For example, one such dust cap strip 70 is shown in FIGS. 6 and 7. In this embodiment, the dust cap strip 70 includes an elongate strip body 72 having a first end 74, an opposed second end 76, and a plurality of dust cap bodies 78 arranged from the first end 74 to the second end 76. Each of the dust cap bodies 78 may be connected to at least one adjacent dust cap body 78 along an interface 80. Each dust cap body 78 is configured to engage with a respective connector port 52a, 52b, 52c, 52d of the adapter 46 or with a respective adapter 46 in the ganged adapter 58. In one embodiment, each dust cap body 78 may include a flange 82 and a plug 84 connected to and extending from the flange 82. In one embodiment, the flange 82 may include a plate-like body having opposed planar surfaces and be generally rectangular in shape. Other shapes of the flange 82, however, may also be possible. The plug 84 extends from one of the planar surfaces of the flange 82 and is configured to be received within at least one of the connector ports 52a, 52b, 52c, 52d of the adapter 46 or be received within an adapter 46 of the ganged adapter 58. In one embodiment, the plug 84 may be generally rectangular in shape and may be solid. In an alternative embodiment, the plug 84 may be generally hollow. For example, as shown in FIG. 7, the plug 84 may include a recess in the outer side of the plug 84 to provide a generally hollow configuration. In one embodiment, the flange 82 may be sized relative to the plug 84 to define a ledge 96 around a periphery 98 of the plug 84.

In one embodiment, at least one of the plurality of the dust cap bodies 78 may include a pull tab 86 extending from the flange 82. For example, the pull tab 86 on the at least one dust cap body 78 may extend from the surface of the flange 82 opposite to the plug 84. In use, the pull tab 86 provides a gripping point to allow an installer to remove the dust cap strip 70 from the adapter 46 or the ganged adapter 58. By way of example, in one embodiment, the dust cap body 78 adjacent to the first end 74 of the elongate strip body 72 and/or the dust cap body 78 adjacent the second end 76 of the elongate strip body 72 may include the pull tab 86 (with the other dust cap bodies 78 omitting the pull tab 86). In an alternative embodiment, however, each of the dust cap bodies 78 of the dust cap strip 70 may include a pull tab 86. As illustrated in FIG. 6, for example, in one embodiment, the pull tab 86 may include an enlarged end piece that may be grasped by the installer to remove the dust cap strip 70 from the connector ports 52a, 52b, 52c, 52d of the adapter 46 or from the adapters 46 of the ganged adapter 58.

In some installation scenarios, only some of the connector ports 52a, 52b, 52c, 52d on the adapter 46 or only some of the adapters 46 of the ganged adapter 58 may need to be accessed. Thus, it may be desirable to remove some of the dust cap bodies 78 of the dust cap strip 70 while maintaining some of the dust cap bodies 78 with the adapter 46 or ganged adapter 58. Accordingly, it may be desirable for the dust cap bodies 78 of the dust cap strip 70 to be separable or severable from each other. In one embodiment, for example, the interface 80 between two adjacent dust cap bodies 78 may include a tear line 88 to facilitate the severability of adjacent dust cap bodies 78 in the dust cap strip 70. The tear line 88 may be a weakened section in the dust cap strip 70 that allows for easy severability. In one exemplary embodiment, for example, the tear line 88 may be formed at least by a plurality of perforations 90. Other ways of forming weaknesses in the dust cap strip 70 may also be possible.

In addition to the above, the dust cap strip 70 may be generally flexible to facilitate the removal of the strip 70 from the adapter 46 or the ganged adapter 58 through a pulling action. In one embodiment, for example, the dust cap strip 70 may be formed from a generally flexible material, such as rubber. In an alternative embodiment, the dust cap strip 70 may be formed from a more rigid material but include one or more flexible sections along the length of the dust cap strip 70. In this regard, and in one embodiment, the interface 80 between adjacent dust cap bodies 78 in the dust cap strip 70 may include a bend line that allows adjacent dust cap bodies 78 to flex relative to each other about the bend line. By way of example and without limitation, the bend line may be formed by a groove 100 in the material of the dust cap strip 70. In one embodiment (not shown), the tear line and the bend line at the interface 80 may be at separate locations. In an alternative embodiment, however, the tear line 88 and the bend line may be formed at the same location in the dust cap strip 70, and therefore coincide with each other. In one embodiment, and as illustrated in FIGS. 6 and 7, the interface 80 between two adjacent dust cap bodies 78 may be along side edges 92, 94 of the flanges 82 of adjacent dust cap bodies 78. Adjacent dust cap bodies 78 may be separated from each other along the tear line 88. The presence of the perforations 90 in the tear line 88 may facilitate separating the adjacent dust cap bodies 78. Additionally, the dust cap strip 70 may bend about the bend lines defined at the interface 80.

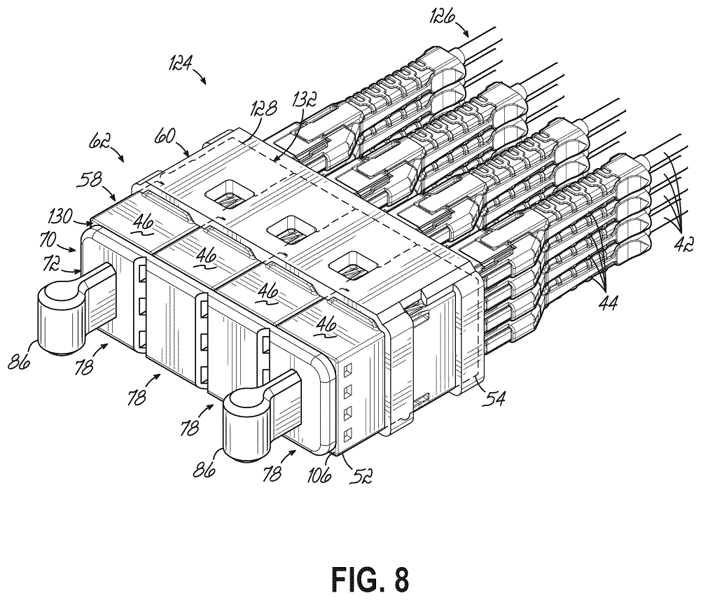

FIG. 8 shows the ganged adapter 58 with the connector ports 52a, 52b, 52c, 52d in each adapter 46 and the dust cap strip 70 engaged with the connector ports 52a, 52b, 52c, 52d of each of the adapters 46. As such, and in this embodiment, the plug 84 of each dust cap body 78 is received in the plurality of connector ports 52a, 52b, 52c, 52d of the respective adapters 46 of the ganged adapter 58. In addition, the flange 82 of each dust cap body 78 is in abutting relationship or near abutting relationship with a connection face 106 of the respective adapters 46 of the ganged adapter 58 adjacent the plurality of connector ports 52a, 52b, 52c, 52d.

While FIG. 8 shows the dust cap strip 70 engaged with all of the connector ports 52a, 52b, 52c, 52d of each of the four adapters 46 of the ganged adapter 58, this same concept may be used in connection with, for example, just a single multiport adapter 46 (FIG. 4). In this regard, in an alternative embodiment, the plugs 84 of the dust cap strip 70 may be configured to be received in the respective connector ports 52a, 52b, 52c, 52d of the multiport adapter 46. Thus, even though the concept may be applied to a single adapter 46 instead of a ganged adapter 58 (as shown in FIG. 8), in such embodiments the dust cap strip 70 still provides the advantage that all of the plugs occluding the connector ports 52a, 52b, 52c, 52d of the adapter 46 may be removed in a single pulling motion of the dust cap strip 70 away from the adapter 46. Thus, it should be understood that at least both of these embodiments are within the scope of the present disclosure.

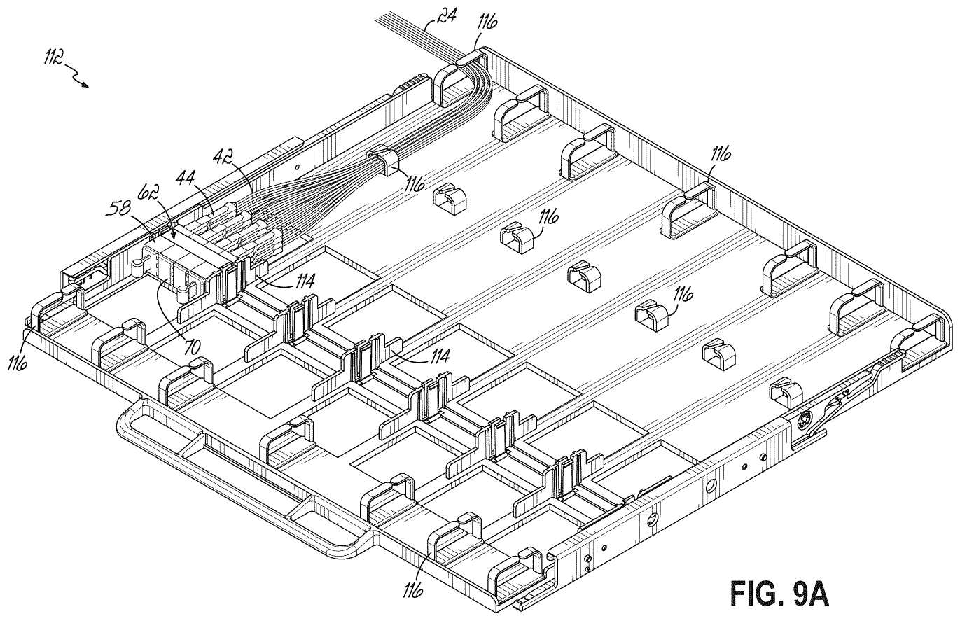

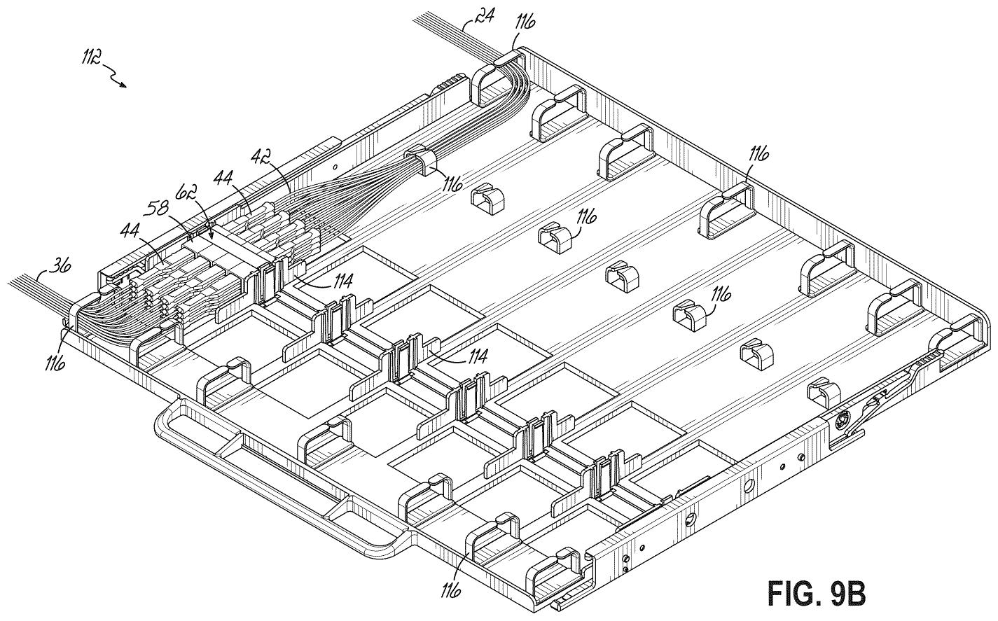

In one embodiment, the intermediate distribution frame 34 may include a plurality of individual tray assemblies (“tray 112”) that may serve as a location to connect the indoor fiber optic cables 24 to the distribution fiber optic cables 36, and ultimately to the network equipment 18 in the racks 32 of the rows 28. An exemplary tray 112 of such an intermediate distribution frame 34 is illustrated in FIG. 9A. The tray 112 includes a plurality of optical interface receivers 114 and a plurality of cable routing guides 116. While only one optical interface 62 is shown in FIG. 9A, it should be appreciated that the tray 112 may include fiber optic cables and optical interfaces in each of the optical interface receivers 114 of the tray 112. FIG. 9A shows one of the indoor cables 24 with the optical interface 62 received In and engaged by the optical interface receiver 114 and further held in place by cable routing guides 116. Because the distribution fiber optic cable 36 is not yet connected to the optical interface 62, and specifically the individual adapters 46, the dust cap strip 70 is received in and engaged with the connector ports 52a, 52b, 52c, 52d of the ganged adapter 58 so as to prevent dust, dirt, and other debris from entering the connector ports 52a, 52b, 52c, 52d, and potentially interfering with the transmission of the optical signals from the indoor fiber optic cables 24 to the distribution fiber optic cables 36 across the adapters 46.

When it is time to connect one or more distribution fiber optic cable 36 to the optical interfaces 62 in the tray 112, the installer may remove the dust cap strip 70 such as by pulling on one of the pull tabs 86. By way of example, the installer may grasp the pull tab 86 at one of the ends of the dust cap strip 70 and pull away to cause each of the dust cap bodies 78 to come away from their respective adapters 46 in the ganged adapter 58 that makes up the optical interface 62. The fiber optic connectors 44 on the distribution cable(s) 36 may then be inserted into the front connector ports 52a, 52b, 52c, 52d on each adapter 46 of the optical interface 62. FIG. 9B shows fiber optic connectors 44 of the distribution fiber optic cable 36 connected to the optical interface 62. In some instances, the distribution fiber optic cable 36 may not be connected to each adapter 46, leaving some of the connector ports 52a, 52b, 52c, 52d open. In that circumstance, the installer may remove one or more of the dust cap bodies 78 to correspond to the adapters 46 that will be used to connect the distribution fiber optic cable 36. The remaining attached dust cap bodies 78 may be used to cover the connector ports 52a, 52b, 52c, 52d that are not being used, i.e., not engaged with a fiber optic connector 44 of the distribution cable 36.

Another aspect of the disclosure contemplates a fiber optic cable assembly. One exemplary fiber optic cable assembly 122 is shown in FIG. 4. Another exemplary fiber optic cable assembly 124 is shown in FIG. 5. The fiber optic cable assembly 122 includes at least one adapter 46 whereas fiber optic cable assembly 124 includes at least one ganged adapter 58. The fiber optic cable assembly 124 includes a fiber optic cable, such as the cable leg 42, having a distribution end 126, a terminal end (not shown), and carrying a plurality of optical fibers (located in the interior of the fiber optical cable, e.g., cable leg 42). The fiber optic cable assembly 124 also includes at least one optical interface 62 at the distribution end 126 of the fiber optic cable for connecting to network equipment 18. The optical interface 62 is of the type shown in and described with respect to FIG. 5. The optical interface 62 further includes the dust cap strip 70 connected to the ganged adapter 58 (FIG. 8). Each of the plurality of adapters 46 of the ganged adapter 58 includes a plurality of front connector ports 52a, 52b, 52c, 52d on a front connection face 106 of the adapter 46 and a plurality of rear connector ports 54a, 54b, 54c, 54d on a rear connection face 128 of the adapter 46. The ganged adapter 58 includes a front ganged connection face 130 including the plurality of front connector ports 52a, 52b, 52c, 52d of the plurality of adapters 46 and a rear ganged connection face 132 including the plurality of rear connector ports 54a, 54b, 54c, 54d from the plurality of adapters 46.

The plurality of fiber optic connectors 44 from, for example, the indoor fiber optic cables 24 may be connected to respective rear connector ports 54a, 54b, 54c, 54d on the rear ganged connection face 132 of the optical interface 62. The dust cap strip 70 may be connected to the front connector ports 52a, 52b, 52c, 52d on the front ganged connection face 130 of the optical interface 62. In one embodiment, each of the plurality of fiber optic connectors 44 includes a multifiber connector (not shown). In one embodiment, each of the plurality of adapters 46 of the at least one optical interface 62 includes at least two, and preferably at least four, front connector ports 52a, 52b, 52c, 52d on the front connection face 106 and at least two, and preferably at least four, rear connector ports 54a, 54b, 54c, 54d on the rear connection interface 128. In one embodiment, the ganged adapter 58 of the optical interface 62 includes at least four adapters 46. In one embodiment, the plurality of adapters 46 may be arranged side-by-side to define the ganged adapter 58 of the optical interface 62. Other arrangements of the adapters 46 to form the ganged adapter 58 is, however, possible and within the scope of the present disclosure.

Another aspect of the disclosure contemplates a method of making a fiber optic cable assembly. The method of making includes providing a fiber optic cable, such as cable leg 42, having a distribution end 126, a terminal end (not shown), and carrying a plurality of optical fibers. The plurality of optical fibers at the distribution end of the fiber optic cable may be terminated by a plurality of fiber optic connectors 44. The method further includes providing the ganged adapter 58 defined by a plurality of adapters 46 arranged adjacent to each other. The ganged adapter includes the first ganged connection face 130 having the plurality of front connector ports 52a, 52b, 52c, 52d of the plurality of adapters 46 and the rear ganged connection face 132 including the plurality of rear connector ports 54a, 54b, 54c, 54d from the plurality of adapters 46. The method further includes inserting each of the plurality of fiber optic connectors 44 of the fiber optic cable into a respective one of the plurality of rear connector ports 54a, 54b, 54c, 54d in the rear ganged connection face 132 of the ganged adapter 58 and applying the dust cap strip 70 into the front connector ports 52a, 52b, 52c, 52d in the front ganged connection face 130 of the ganged adapter 58.

In this embodiment, the adapter element, e.g., the adapter 46 or the ganged adapter 58, forms part of the fiber optic cable assembly, i.e., at the optical interface 62, for example. This contrasts with the adapter element typically being pre-installed in the intermediate distribution frame and fiber optic connectors being inserted into both ends of the adapters during installation, as with conventional approaches. In this embodiment, the fiber optic cable assembly may then be routed through the data center 10, for example, and to the intermediate distribution frame 34, where the optical interface 62 may be connected to the tray 112, as described above. The method described above may then be performed to form optical connections across the adapter elements. By forming the optical interface 62 as part of the fiber optic cable assembly, installation labor and time may be significantly reduced. Additionally, since the fiber optic cable assembly having the optical interface 62 may be made in a factory setting, faulty optical connections, and the time and labor associated with their resolution, may be significantly reduced. Thus, several advantages may be gained by including the adapter element as part of the fiber optic cable assembly instead of as a separate component pre-installed in the intermediate distribution frame 34, for example.

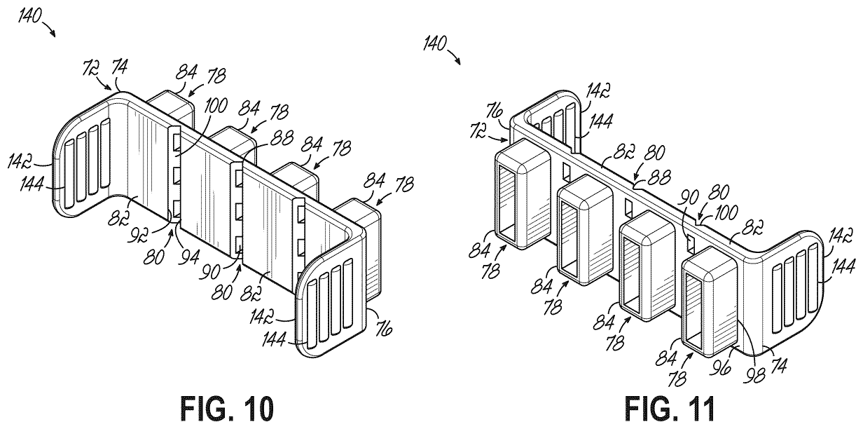

FIGS. 10 and 11 show another exemplary dust cap strip 140 in accordance with the disclosure. Dust cap strip 140 includes many of the same features as the dust cap strip 70, as indicated by like reference numbers. However, the dust cap strip 140 has pull tabs 142 that have a different configuration (e.g., shape) as compared to pull tabs 86. For example, in this embodiment, the pull tabs 142 extend generally outward from the first and second ends 74, 76 of the elongate strip body 72. In one embodiment, the pull tabs 142 may extend from the elongate strip body 72 in a substantially perpendicular manner (e.g., +\−10°). Other angles, however, may be possible. Additionally, in other embodiments, only a single pull tab 142 may be provided, either on the first end 74 or second end 76. In one embodiment, the pull tabs 142 may include ribbing 144 on one or both sides of the pull tabs 142 to enhance the grip the installer has on the pull tab 142 as the dust cap strip 140 is being pulled away from the adapter element. The one or more pull tabs 142 may be integrally formed with the elongate strip body 72 such that the dust cap trip has a monolithic construction.

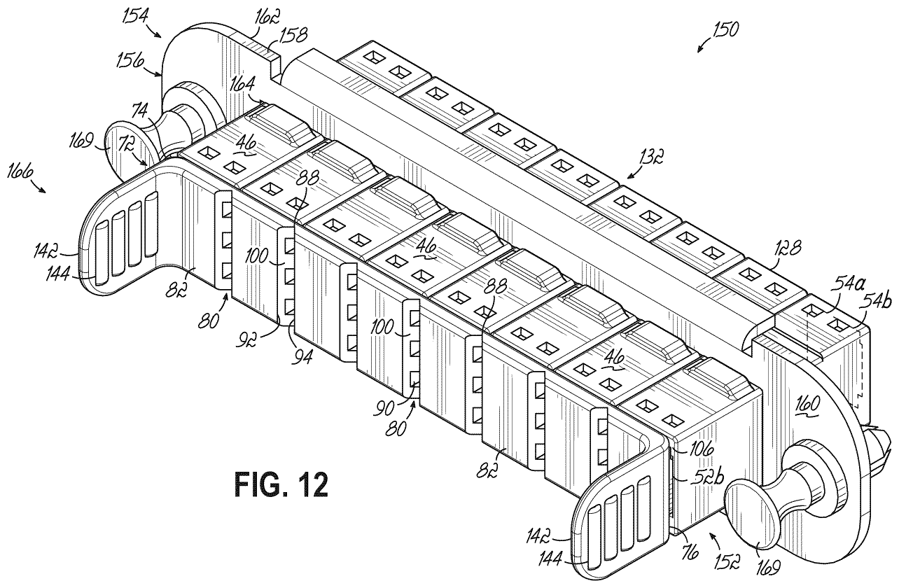

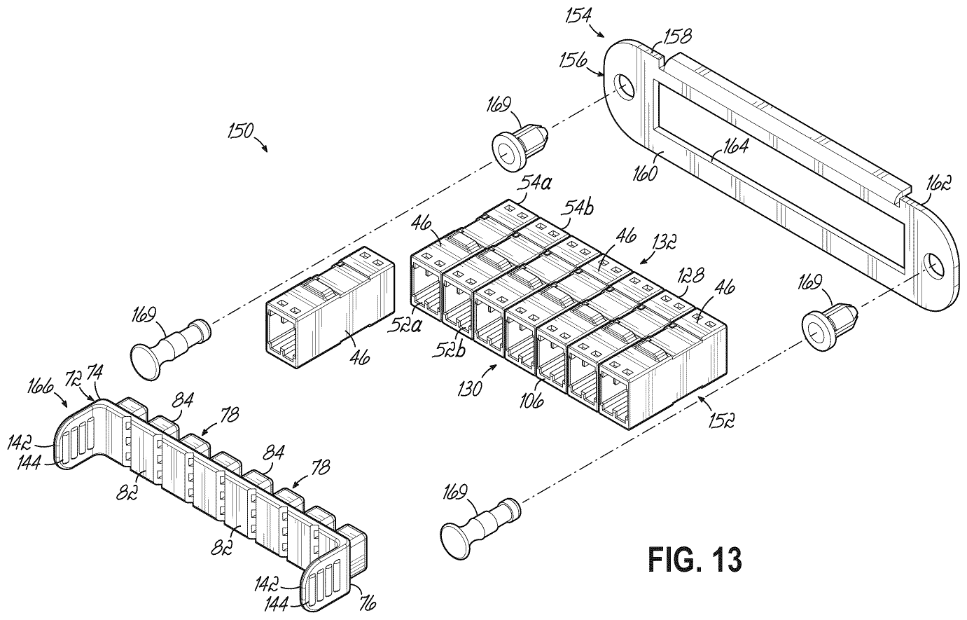

FIGS. 12 and 13 illustrate an optical interface 150, such as for a fiber optic cable assembly (not shown). Similar to optical interface 62 described above, optical interface 150 includes a ganged adapter 152 and an interface housing 154 for holding the plurality of adapters 46 that form the ganged adapter 152. In this embodiment, the interface housing 154 includes a bezel plate 156 for holding the plurality of adapters 46. The bezel plate 156 includes a flat elongate body 158 having a front side 160 and a rear side 162. The elongate body 158 includes at least one opening 164 for receiving one or more of the adapters 46. In the illustrated embodiment, the elongate body 158 includes one opening 164 for receiving a plurality of adapters 46. More particularly, the opening 164 may be configured to receive eight adapters in a side-by-side arrangement. The opening 164, however, may be configured to receive more or less than this number in alternative embodiments. Moreover, the plurality of adapters 46 may be arranged in a single row, for example. However, other arrangements of the plurality of adapters 46 in the bezel plate 156 may be possible and remain within the scope of the present disclosure, as discussed below in more detail.

Similar to the above, each of the plurality of adapters 46 of the ganged adapter 152 includes a plurality of front connector ports 52a, 52b on a front connection face 106 of the adapter 46 and a plurality of rear connector ports 54a, 54b on a rear connection face 128 of the adapter 46. The ganged adapter 58 includes a front ganged connection face 130 including the plurality of front connector ports 52a, 52b of the plurality of adapters 46 and a rear ganged connection face 132 including the plurality of rear connector ports 54a, 54b from the plurality of adapters 46. In one embodiment, each of the plurality of adapters 46 of the at least one optical interface 150 includes at least two, and preferably at least four, front connector ports 52a, 52b on the front connection face 106 and at least two, and preferably at least four, rear connector ports 54a, 54b on the rear connection interface 128. A plurality of fiber optic connectors 44 from, for example, the indoor fiber optic cables 24 may be connected to respective rear connector ports 54a, 54b, 54c, 54d on the rear ganged connection face 132 of the optical interface 150 (not shown). The dust cap strip 166 may be connected to the front connector ports 52a, 52b on the front ganged connection face 130 of the optical interface 150. Dust cap strip 166 is similar to that shown in FIGS. 10 and 11 and similar reference numbers refer to like features shown in those figures.

Similar to the above, the interface housing 154 (which may take the form of the bezel plate 156 in the illustrated embodiment) may be configured to be coupled to, for example, a patch panel 168, such as a patch panel in an intermediate distribution frame 34 or other racking/patching structure of the fiber optic network. In an alternative embodiment, for example, the patch panel 168 may form part of an equipment rack 32 in a row 28 of a data hall 26. In this regard, the bezel plate 156 may include at least one releasable connector for attaching the bezel plate 156 to the patch panel 168. In one embodiment, the at least one releasable connector may include at least one push pin 169 for being pushed into and pulled out of openings in the patch panel 168 (not shown). In one embodiment, the bezel plate 156 may include a pair of push pins 169 on, for example, opposite sides of the opening 164 in the bezel plate 156 that receives the plurality of adapters 46. Other arrangements of the push pins 169 area also possible

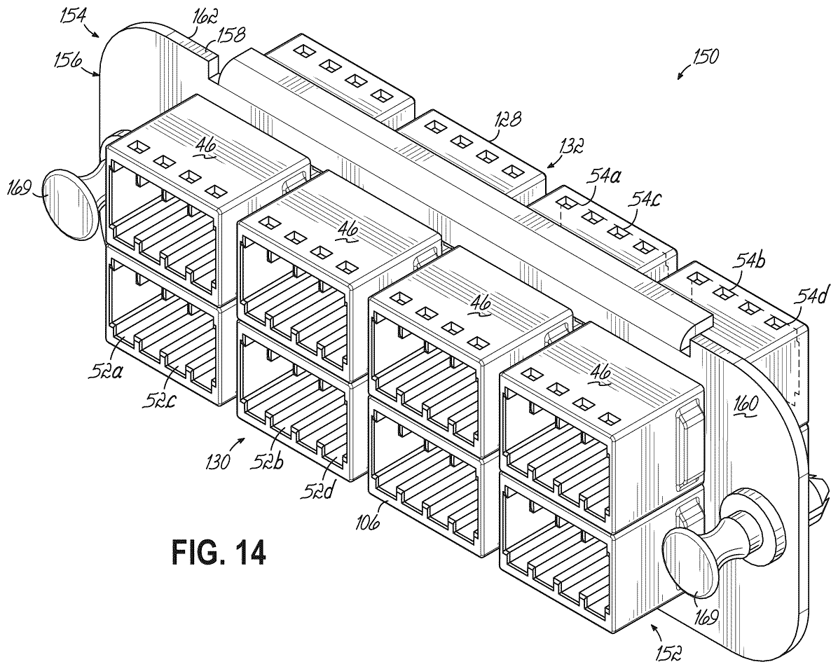

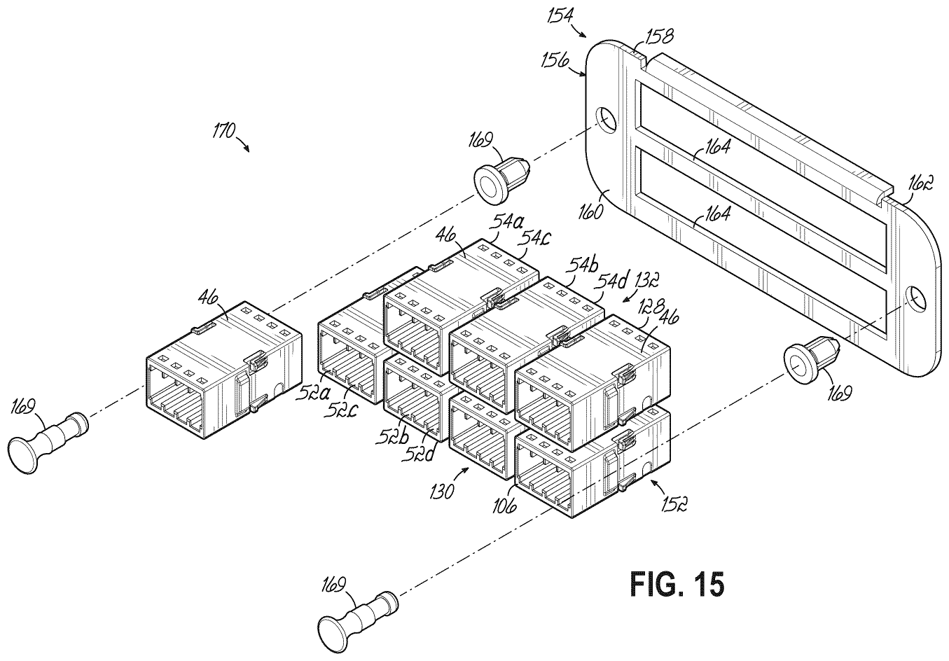

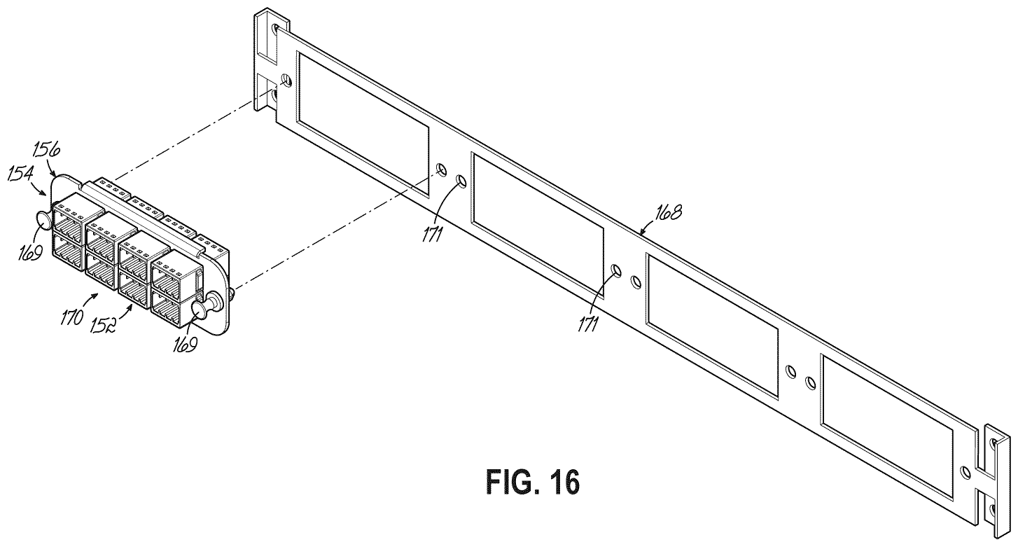

FIGS. 14 and 15 illustrate another embodiment of an optical interface 170 in accordance with the disclosure that may be used with, for example, a fiber optic cable assembly (not shown). The optical interface 170 is similar to the optical interface 150 and like reference numbers will refer to like features illustrated in FIG. 12 and described above. Similar to optical interface 150 described above, optical interface 170 includes an interface housing 154 for holding the plurality of adapters 46 that form an adapter array 172. The primary difference between optical interface 170 and optical interface 150 is that the interface housing 154 takes the form of a bezel plate 156 having a pair of openings 164 positioned one on top of the other in the elongate body 158 of the bezel plate 156. Each of the openings 164 may be configured to receive a plurality of adapters 46 (e.g., four adapters 46) in a side-by-side arrangement. However, the openings 164 may be configured to receive more or less than this number in alternative embodiments. Moreover, the plurality of adapters 46 may be arranged so that the adapter array 172 has a plurality of rows and a plurality of columns, such as two rows and four columns, for example. However, other arrangements of the plurality of adapters 46 in the bezel plate 156 may be possible and remain within the scope of the present disclosure.

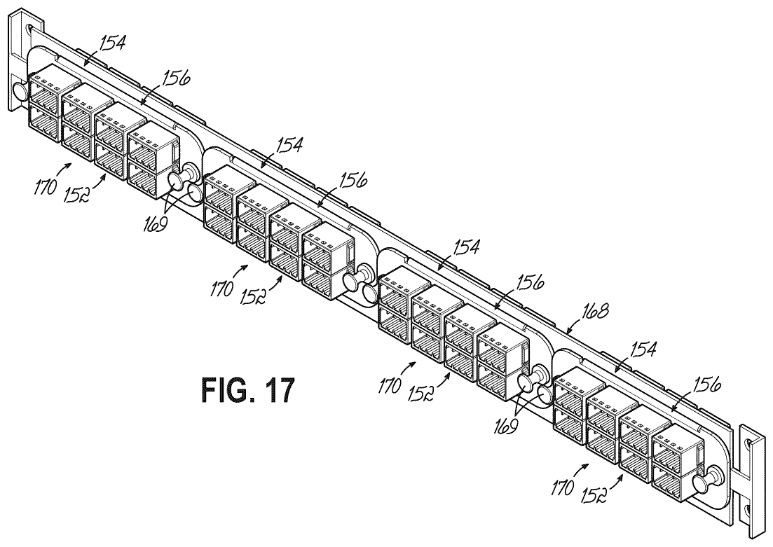

Similar to the above, the interface housing 170 may be configured to be coupled to, for example, a patch panel 168, such as a patch panel in an intermediate distribution frame 34 or other racking/patching structure in the fiber optic network (not shown). In an alternative embodiment, for example, the patch panel 168 may form part of an equipment rack 32 in a row 28 of a data hall 26. A plurality of fiber optic connectors 44 from, for example, the indoor fiber optic cables 24 may be connected to respective rear connector ports 54a, 54b, 54c, 54d on the rear array connection face 132 of the optical interface 170 (not shown). At least one dust cap strip 166 may be connected to the front connector ports 52a, 52b, 52c, 52d on the front array connection face 130 of the optical interface 170. In one embodiment, each row of the adapter array 172 may include a dust cap strip 166. In an alternative embodiment, a single dust cap strip 166 may be used to cover the front connector ports 52a, 52b, 52c, 52d of all the rows of the adapter array 172 (i.e., a single dust cap strip 166 for the embodiment shown in FIGS. 14 and 15). Dust cap strip 166 may be similar to that shown in FIGS. 10 and 11. Alternatively, the dust cap strip 166 may be similar to that shown in FIGS. 6 and 7. FIGS. 16 and 17 illustrate a plurality of optical interfaces 170 attached to, for example, a patch panel 168, such as a patch panel in an intermediate distribution frame 34. In an alternative embodiment, the patch panel 168 may form part of an equipment rack 32 in a row 28 of a data hall 26. In this regard, the push pins 169 may be received in corresponding openings 171 in the patch panel 168 to secure the optical interface thereto.

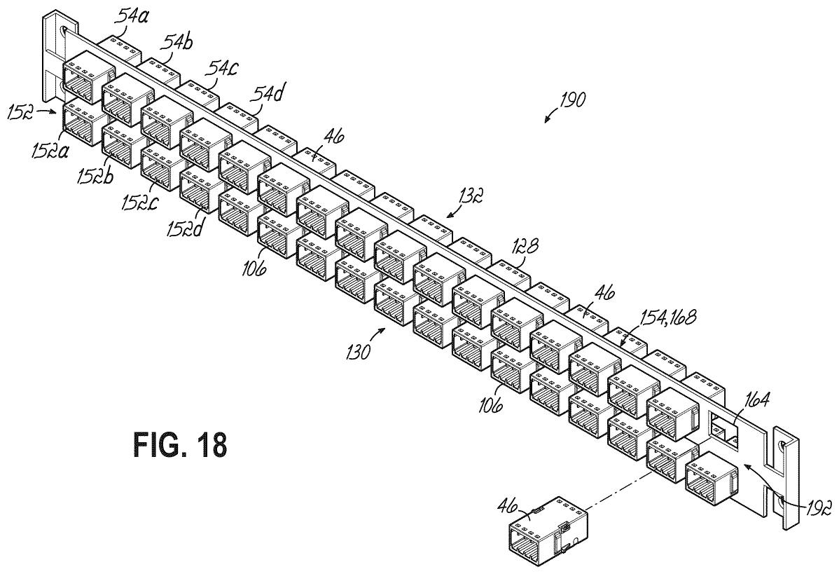

FIG. 18 illustrates still a further embodiment of an optical interface 190 in accordance with the disclosure that may be used with, for example, a fiber optic cable assembly (not shown). The optical interface 190 is similar to the optical interfaces 150 and 170 and like reference numbers will refer to like features illustrated in FIGS. 12-15 and described above. Similar to optical interfaces 150 and 170 described above, optical interface 190 includes an interface housing 154 for holding the plurality of adapters 46. One primary difference between optical interfaces 150 and 170 and optical interface 190 is that each of the openings 164 in the interface housing 154 is configured to receive only a single adapter 46, instead of a plurality of adapters in a side-by-side arrangement, for example. This allows spacing between adjacent adapters 46 to be slightly increased, which may improve installation. Another primary difference between optical interfaces 150 and 170 and optical interface 190 is that in this embodiment, the interface housing 154 takes the form of the patch panel 168 itself, instead of a bezel plate 156 configured to be attached to the patch panel 168, as shown in FIGS. 15 and 16, for example.

As illustrated in FIG. 18, the patch panel 168 includes a plurality of openings 164 in an array 192 of a plurality of rows and columns. As noted above, each of the openings 164 in the patch panel 168 is configured to receive only a single adapter 46, instead of a plurality of adapters in a side-by-side arrangement, for example. However, the adapters 46 are attached directly to the patch panel 168 without, for example, a bezel plate 156 or other intermediate structural element. Thus, the patch panel 168 operates as the interface housing 154 for the optical interface 190. A plurality of fiber optic connectors 44 (FIG. 4) from, for example, the indoor fiber optic cables 24 may be connected to respective rear connector ports 54a, 54b, 54c, 54d on the rear array connection face 132 of the optical interface 190. At least one dust cap strip 166 may be connected to the front connector ports 52a, 52b, 52c, 52d on the front array connection face 130 of the optical interface 190. In one embodiment, for example, each row (or each column) of the array 192 may include a single dust cap strip 166. In an alternative embodiment, a single dust cap strip 166 may be used to cover the front connector ports 52a, 52b, 52c, 52d of a plurality of rows (or alternatively a plurality of columns) of the array 192 on the front array connection face 130 of the optical interface 170. By way of example, each dust cap strip 166 may be used to cover two or three rows (or two or three columns) of the front connector ports 52a, 52b, 52c, 52d on the front array connection face 130 of the optical interface 170. Dust cap strip 166 may be similar to that shown in FIGS. 10 and 11. Alternatively, the dust cap strips 166 may be similar to that shown in FIGS. 6 and 7.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A dust cap strip for an adapter element used for making connections in a fiber optic network, the adapter element including a plurality of connector ports and a connection face adjacent the plurality of connector ports, the dust cap strip comprising:
an elongate strip body having a first end, a second end, and a plurality of dust cap bodies extending between the first end and the second end, wherein each of the plurality of dust cap bodies is connected to at least one adjacent dust cap body along an interface, and wherein each of the plurality of dust cap bodies, comprises:
a flange; and
a plug connected to and extending from the flange,
wherein when the dust cap strip is engaged with the adapter element:
the plug of each of the plurality of dust cap bodies is received in at least one of the plurality of connector ports of the adapter element, and
the flange of each of the plurality of dust cap bodies is in abutting relationship or near abutting relationship with the connection face of the adapter element adjacent the at least one of the plurality of connector ports.

2. The dust cap strip of claim 1, wherein the elongate strip body is flexible.

3. The dust cap strip of claim 1, wherein the interface between two adjacent dust cap bodies of the plurality of dust cap bodies includes either a tear line having perforations or a bend line having a groove.

4. The dust cap strip of claim 1, wherein the interface between two adjacent dust cap bodies of the plurality of dust cap bodies includes both a tear line having perforations and a bend line having a groove, and wherein the tear line and the bend line coincide with each other.

5. The dust cap strip of claim 1, wherein the interface between two adjacent dust cap bodies of the plurality of dust cap bodies is along side edges of the respective flanges.

6. The dust cap strip of claim 1, wherein for each dust cap body of the plurality of dust cap bodies, the flange is sized relative to the plug to define a ledge around a periphery of the plug.

7. The dust cap strip of claim 1, wherein the plug is generally hollow.

8. The dust cap strip of claim 1, wherein the dust cap body adjacent the first end of the elongate strip body and/or the dust cap body adjacent the second end of the elongate strip body includes the pull tab a pull tab extending from the flange of the dust cap body.

9. The dust cap strip of claim 8, wherein the pull tab extends from a side of the flange opposite the plug.

10. A fiber optic assembly, comprising:
an adapter element used for making connections in a fiber optic network, the adapter element including a plurality of connector ports and a connection face adjacent the plurality of connector ports; and
at least one dust cap strip engaged with the adapter element, wherein each dust cap strip of the at least one dust cap strip comprises:
an elongate strip body having a first end, a second end, and a plurality of dust cap bodies extending between the first end and the second end, wherein each of the plurality of dust cap bodies is connected to at least one adjacent dust cap body along an interface, and wherein each of the plurality of dust cap bodies, comprises:
a flange; and
a plug connected to and extending from the flange,
wherein:
the plug of each of the plurality of dust cap bodies is received in at least one of the plurality of connector ports of the adapter element, and
the flange of each of the plurality of dust cap bodies is in abutting relationship or near abutting relationship with the connection face of the adapter element adjacent the at least one of the plurality of connector ports.

11. The fiber optic assembly of claim 10, wherein the adapter element includes an adapter having the plurality of connector ports, and wherein each of the plurality of dust cap bodies is configured to be received in a respective one of the plurality of connector ports of the adapter.

12. The fiber optic assembly of claim 10, wherein the adapter element includes a ganged adapter comprising plurality of adapters arranged adjacent to each other, wherein each adapter of the plurality of adapters includes at least one connector port of the plurality of connector ports, and wherein each of the plurality of dust cap bodies is configured to be partially received in the at least one connector port of a respective adapter of the plurality of adapters in the ganged adapter.

13. The fiber optic assembly of claim 12, further comprising a housing configured to hold the ganged adapter.

14. The fiber optic assembly of claim 13, wherein the housing includes at least one of the following:
an interface band for holding the plurality of adapters in the ganged adapter;
a bezel plate for holding the plurality of adapters in the ganged adapter; or
a panel for holding the plurality of adapters in the ganged adapter.

15. The fiber optic assembly claim 14, wherein the plurality of adapters are arranged in an array having a least one row or at least one column, and wherein each of the plurality of dust cap bodies of the at least one dust cap strip is configured to be partially received in the at least one connector port of a respective adapter of the plurality of adapters in the ganged adapter that forms the at least one row or the at least one column in the array.

16. The fiber optic assembly of claim 15, wherein the array includes a plurality of rows and a plurality of columns, and wherein each of the plurality of dust cap bodies of the at least one dust cap strip is configured to be partially received in the at least one connector port of a respective adapter of the plurality of adapters in the ganged adapter that forms at least two rows or at least two columns in the array.

17. The fiber optic assembly of 15, wherein the array includes a plurality of rows and a plurality of columns, wherein the at least one dust cap strip includes a plurality of dust cap strips, and wherein each of the plurality of dust cap bodies of each dust cap strip is configured to be partially received in the at least one connector port of a respective adapter of the plurality of adapters in the ganged adapter that forms one row or one column in the array.

18. A fiber optic cable assembly, comprising:
a fiber optic cable carrying a plurality of optical fibers; and
at least one optical interface at an end of the fiber optic cable for connection to network equipment, the at least one optical interface comprising:
a plurality of fiber optic connectors terminating at least some of the plurality of optical fibers at the end of the fiber optic cable;
a plurality of adapters arranged adjacent to each other to define an adapter array; and
at least one dust cap strip connected to the ganged adapter, the dust cap strip comprising:
an elongate strip body having a first end, a second end, and a plurality of dust cap bodies extending between the first end and the second end, wherein each of the plurality of dust cap bodies is connected to at least one adjacent dust cap body along an interface, and wherein each of the plurality of dust cap bodies, comprises:
a flange; and
a plug connected to and extending from the flange,
wherein:
each of the plurality of adapters of the adapter array includes at least one first connector port on a first connection face of the adapter and at least one second connector port on a second connection face of the adapter, such that the adapter array includes a plurality of the first connector ports and a plurality of the second connector ports,
the adapter array includes a first array connection face including the plurality of first connector ports and a second array connection face including the plurality of second connector ports;
each fiber optic connector of the plurality of fiber optic connectors is connected to a respective second connector port of the plurality of second connector ports,
the at least one dust cap strip is connected to the plurality of first connector ports on the first array connection face of the optical interface,
each of the plurality of dust cap bodies of the at least one dust cap strip is partially received in the at least one first connector port of a respective adapter of the plurality of adapters in the adapter array, and
the flange of each of the plurality of dust cap bodies is in abutting relationship or near abutting relationship with the first array connection face of the adapter array.

19. The fiber optic cable assembly of claim 18, wherein each adapter of the plurality of adapters of the at least one optical interface includes a plurality of first connector ports on the first connection interface and a plurality of second connector ports on the second connection interface.

20. The fiber optic cable assembly of claim 19, wherein each adapter of the plurality of adapters of the at least one optical interface includes:
at least two first connector ports on the first connection interface, and
at least two second connector ports on the second connection interface.
